(19) United States
(12) Patent Application Publication
(10) Pub. No.: US 2025/0001956 A1
(43) Pub. Date: Jan. 2, 2025

(54) APPARATUS, SYSTEM, AND METHOD FOR VEHICLE FLOOR SILENCER WITH SILENCER WALL

(71) Applicant: Toyota Motor Engineering & Manufacturing North America, Inc., Plano, TX (US)

(72) Inventors: Timothy S. Holmes, Ann Arbor, MI (US); Xinle Zhou, Novi, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/215,049

(22) Filed: Jun. 27, 2023

(51) Int. Cl. B60R 13/08; B60R 16/02

(52) U.S. Cl. CPC B60R 13/0815; B60R 16/0215

(57) ABSTRACT

Apparatuses, systems, and methods for vehicle floor silencers include a silencer wall extending from a floor of the vehicle floor silencer and creating a barrier between an unsecured portion of a wire harness and a shift lever boot. The floor can be configured to be mounted to a vehicle support liner. The silencer wall can protrude from the floor. The silencer wall can be located immediately adjacent the shift lever boot (e.g., the silencer wall can at least partially define an opening through the floor so as to accommodate the shift lever boot). The vehicle floor silencer (i.e., the floor and the silencer wall in combination) can be fabricated as a single, monolithic piece.

### BACKGROUND

### Field

The present disclosure relates to apparatuses, systems, and methods for vehicle interiors and, more particularly, to a floor silencer to be installed between a vehicle floor and an interior carpeting.

### Description of the Related Art

Unwanted engine noise and vibrations can enter the passenger compartment of a vehicle through the front and bottom of the passenger compartment near the fire wall and wheels, among other locations. Most vehicles have a layer of metal defining the floor of the passenger compartment which separates the passenger compartment from the exterior of the vehicle and which tends to mitigate some noise and vibration. Generally, the thicker the metal floor of the vehicle, the more sound mitigation the metal floor provides. However, increasing the thickness of the metal floor increases the weight of the vehicle, which tends to reduce the efficiency of the vehicle. Some modern vehicles use sound-absorbing materials to help isolate vehicle users inside the cabin from unwanted engine and road noise. For example, carpeting is provided at the floor of most vehicles which tends to absorb some, but not all, vibration and sound. Mitigating exterior noise entering the passenger compartment of a vehicle generally improves user experience and desirability to drive a particular vehicle.

Accordingly, there is a need for systems and methods for vehicles that can provide improved sound insulation within a vehicle interior.

Moreover, during assembly of a vehicle, one or more wires or cables may be routed along the floor of the vehicle. The wire(s) can be used for transferring power and/or wireless signals to various electronic devices onboard the vehicle. The wire(s) may be secured to the vehicle floor at distinct locations above the vehicle floor using fasteners or tie downs to prevent movement of the wire(s) relative to adjacent components. Routing and securing the wire(s) to the vehicle floor with fasteners or tie downs, however, can be difficult and time consuming.

### SUMMARY

Described herein is a vehicle floor silencer including a floor configured to be mounted to, and conform to, a vehicle support liner, and a silencer wall protruding from the floor and at least partially defining an opening through the floor so as to accommodate a shift lever boot.

Also described is a floor silencer system for a vehicle. The floor silencer system includes a support liner, a floor silencer including a floor at least partially covering the support liner and a silencer wall protruding from the floor, a shift lever boot extending at least partially into the opening, and a wire harness extending across the floor silencer and separated from the shift lever boot by the silencer wall. The floor extends along and conforms to the support liner. The silencer wall is disposed at an opening in the floor silencer.

Moreover, also described is a method for preventing an unsecured portion of a vehicle's wire harness from interfering with the vehicle's shift lever boot. The method includes coupling a vehicle floor silencer to a vehicle support liner, supporting the vehicle floor silencer with the vehicle support liner, coupling a shift lever boot to the vehicle support liner such that the shift lever boot extends at least partially into an opening disposed in the vehicle floor silencer, and separating an unsecured portion of a wire harness from the shift lever boot with a silencer wall protruding from a floor of the vehicle floor silencer.

### BRIEF DESCRIPTION OF THE DRAWINGS

Other systems, methods, features, and advantages of the present disclosure will be or will become apparent to one of ordinary skill in the art upon examination of the following figures and detailed description. It is intended that all such additional systems, methods, features, and advantages be included within this description, be within the scope of the present disclosure, and be protected by the accompanying claims. Component parts shown in the drawings are not necessarily to scale and may be exaggerated to better illustrate the important features of the present disclosure. In the drawings, like reference numerals designate like parts throughout the different views, wherein:

FIG. 1A is a schematic perspective view of a floor silencer system according to an embodiment of the present disclosure;

FIG. 1B is a schematic section view of the floor silencer system shown in FIG. 1A according to an embodiment of the present disclosure;

FIG. 2 is a top, plan view of the floor silencer system according to an embodiment of the present disclosure; and

FIG. 3 is a flowchart illustrating a method for preventing an unsecured portion of a vehicle's wire harness from interfering with the vehicle's shift lever boot according to an embodiment of the present disclosure.

### DETAILED DESCRIPTION

The present disclosure describes apparatuses, systems, and methods for vehicle floor silencers. A vehicle floor silencer includes a silencer wall or barrier formed integrally with a body or floor of the vehicle floor silencer. Vehicle wire harnesses may be secured to portions of the vehicle (e.g., to a floor silencer) at distinct fixed locations. However, between the fixed locations, wires and components of the wire harness may move around. For example, there is a possibility that a wire harness may interfere with a vehicle's shift lever boot. The silencer wall of the present disclosure prevents an unsecured portion of a vehicle's wire harness from interfering with the vehicle's shift lever boot.

Apparatuses, systems, and methods of the present disclosure prevent interference by the wire harness with the shift lever boot while also performing the function of reducing noise and vibration in the vehicle. By providing multiple benefits with a single part, the overall weight, packaging, and/or part count of the vehicle floor silencer system can be reduced.

It will be appreciated that for simplicity and clarity of illustration, where appropriate, reference numerals have been repeated among the different figures to indicate corresponding or analogous elements. Similar reference numerals shown in different embodiments may refer to similar features or elements common to the different embodiments. In addition, the discussion outlines numerous specific details to provide a thorough understanding of the embodiments described herein. Those of skill in the art, however, will understand that the embodiments described herein may be practiced using various combinations of these elements.

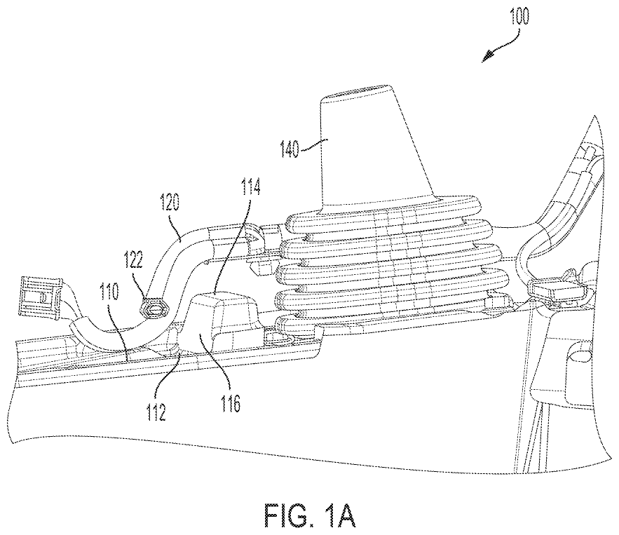

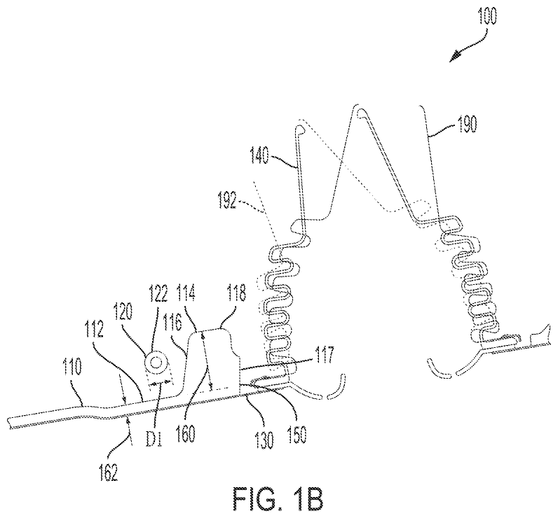

Referring to the drawings, wherein like reference numbers correspond to like or similar components throughout the several figures, FIG. 1A is a perspective view of a portion of a vehicle floor silencer system 100. FIG. 1B is a section view of the vehicle floor silencer system 100 of FIG. 1A. With combined reference to FIG. 1A and FIG. 1B, the floor silencer system 100 includes a vehicle floor silencer 110 including a silencer floor 112 and a silencer wall 114 protruding from the silencer floor 112. A wire harness 120 can be mounted to, and routed along, the floor silencer 110. The wire harness 120 may be secured to the floor silencer 110 at distinct locations above the vehicle floor. The wire harness 120 can be used for transferring electric signals and/or power to one or more electronic devices onboard the vehicle. The floor silencer 110 can be mounted to a support liner 130. In various embodiments, the support liner 130 is made of a sheet of metal (sometimes referred to as sheet metal). An interior carpet can be installed over the floor silencer 110. The silencer floor 112 can be a panel, sheet, or layer of sound insulating material that covers and conforms to the floor of the vehicle—i.e., the support liner 130. In this regard, the silencer floor 112 can contour with the support liner 130. The floor silencer 110 may aid in insulating the vehicle interior from noise and vibration from the floor and/or from the exterior of the vehicle.

A shift lever boot 140 can be coupled to the support liner 130. An opening 150 is disposed in the floor silencer 110 and is configured to accommodate the shift lever boot 140. The shift lever boot 140 can extend at least partially into the opening 150. Moreover, the support liner 130 can extend from the floor silencer 110 into the opening 150 to provide a surface to which the shift lever boot 140 is mounted. In this regard, the support liner 130 can support both the floor silencer 110 and the shift lever boot 140. In various embodiments, the silencer wall 114 at least partially defines the opening 150 such that the silencer wall 114 is located adjacent to the shift lever boot 140. Stated differently, the silencer wall 114 can be located at the opening 150. The silencer wall 114, however, is spaced apart from the shift lever boot 140 to allow freedom of motion thereof.

The silencer wall 114 is located between the shift lever boot 140 and the wire harness 120. With the silencer wall 114 located at only one side of the wire harness 120, an unsecured portion of the wire harness 120 can be blocked from moving toward the shift lever boot 140, while remaining free to move away from the shift lever boot 140, in various embodiments. The floor silencer 110 is configured to reduce noise in a vehicle cabin (i.e., inside the vehicle). The floor silencer 110, via the silencer wall 114, is further configured to separate the wire harness 120 from the shift lever boot 140. The silencer wall 114 can at least partially define a path for the wire harness 120. In this regard, the silencer wall 114 can both reduce noise in the vehicle cabin and separate the wire harness 120 from the shift lever boot 140 to prevent the wire harness 120 from interfering with the shift lever boot 140.

The silencer wall 114 can be configured to separate a portion 122 of the wire harness 120 which extends laterally along the floor silencer 110 adjacent to the silencer wall 114. The silencer wall 114 can be located immediately adjacent the shift lever boot 140. The portion 122 of the wire harness 120 may be unsecured to the silencer wall 114 (i.e., is not connected to the silencer wall 114) such that the wire harness 120 is free to move with respect to the floor silencer 110. Stated differently, the portion 122 can be an unsecured portion of the wire harness 120 which extends across the floor silencer 110. The silencer wall 114 can prevent the portion 122 of the wire harness 120 from unintentional rubbing, wear, or binding against the shift lever boot 140. The silencer wall 114 can prevent the portion 122 of the wire harness 120 from contacting the shift lever boot 140, which moves between a forwardmost position 190 (see FIG. 1B) and a rearmost position 192 (see FIG. 1B) together with a vehicle shift lever when shifting the transmission of the vehicle between gears. In this regard, the wire harness 120 can be located immediately adjacent the silencer wall 114. In this arrangement, the wire harness 120 may lay adjacent to the silencer wall 114 without needing to be secured to the floor silencer 110.

With reference to FIG. 1B, a section view of the vehicle floor silencer system 100 is illustrated. The silencer wall 114 can include a discrete protrusion (e.g., a tab or the like) protruding from the floor 112. The silencer wall 114 can have a substantially rectangular geometry. For example, the silencer wall 114 can be a substantially rectangular device protruding from the floor 112. The silencer wall 114 can also be tapered. The silencer wall 114 can include a rectangular prism protruding from the floor 112. The silencer wall 114 can include a cuboid protruding from the floor 112. The shift lever boot 140 extends beyond the silencer wall 114 (i.e., the shift lever boot 140 is taller than the silencer wall 114).

The silencer wall 114 may protrude from the floor silencer 110 a suitable distance to stop the wire harness 120 from moving toward the shift lever boot 140. In various embodiments, the silencer wall 114 protrudes above the wire harness 120. The silencer wall 114 can include a height 160 of between 2 and 20 times a thickness 162 of the silencer wall 114 in various embodiments, between 4 and 20 times the thickness 162 of the silencer wall 114 in various embodiments, between 5 and 15 times the thickness 162 of the silencer wall 114 in various embodiments, and between 6 and 12 times the thickness 162 of the silencer wall 114 in various embodiments. The silencer wall 114 can include a height 160 of between 0.5 inches and 4 inches.

In various embodiments, the dimensions of the silencer wall 114 (e.g., particularly the height 160 of the silencer wall 114) can be specified and/or chosen with respect to an outer diameter D1 of wire harness 120. For example, the height 160 of the silencer wall 114 can be chosen to be equal to or greater than the outer diameter DI of the wire harness 120. The height 160 of the silencer wall 114 can be between 1 and 6 times the outer diameter D1 of wire harness 120 in various embodiments, between 2 and 6 times the outer diameter D1 of wire harness 120 in various embodiments, and between 3 and 5 times the outer diameter D1 of wire harness 120.

With combined reference to FIG. 1A and FIG. 1B, the silencer wall 114 can include a first side surface 116 extending from the floor 112 of the floor silencer 110 to a top surface 118 of the silencer wall 114. The first side surface 116 can be oriented at an obtuse angle with respect to the floor 112; though in various embodiments, the first side surface 116 is oriented perpendicular with respect to the floor 112 or at an acute angle with respect to the floor 112. The angle of the surface 116 can facilitate placement of the wire harness 120. The first side surface 116 is located opposite the silencer wall 114 from the opening 150. The silencer wall 114 can include a second side surface 117 defining the opening 150. The second side surface 117 can be angled toward the opening 150 (i.e., can lean toward the opening 150). The angle of the first side surface 116 and/or the second side surface 117 can be chosen depending on the orientation of the support liner 130 and/or the angle of the shift lever boot 140 with respect to the support liner 130. The floor 112 may include a thin sheet or layer of material configured to cover, and conform to, the support liner 130 to mitigate noise in the cabin of the vehicle. In this regard, the floor 112 can include a broad stretch or surface of sound-insulating material. The floor silencer 110 may be molded or otherwise fabricated from a synthetic fiber/urethane mixture. The floor silencer 110 may be formed from a foam material, a polymer, or any other suitable material or materials. The floor 112 and the silencer wall 114 can be formed as a monolithic part. For example, the floor 112 and the silencer wall 114 can be molded or otherwise fabricated as a single part.

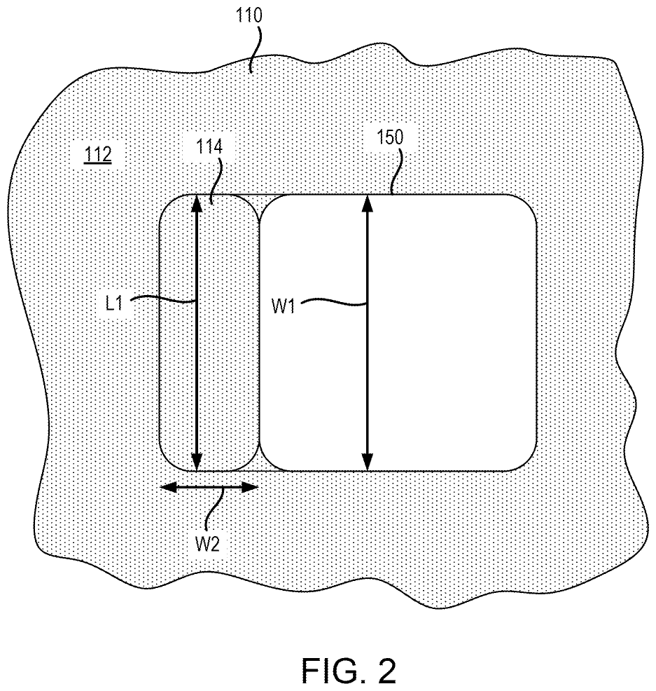

With reference to FIG. 2, a top, plan view of the floor silencer 110 is illustrated, in accordance with various embodiments. A length L1 (measured in and out of the page in FIG. 1B) of the silencer wall 114 can be approximately equal to a dimension (e.g., a width W1) of the opening 150 such that the length L1 of the silencer wall 114 is approximately equal to the width W1 of the shift lever boot 140. In various embodiments, the length L1 of the silencer wall 114 is between 50% and 110% of the width W1 of the shift lever boot 140. In various embodiments, the length L1 of the silencer wall 114 is between 80% and 110% of the width W1 of the shift lever boot 140. The length L1 of the silencer wall 114 and the width W1 of the shift lever boot 140 are measured along the same direction (i.e., in and out of the page in FIG. 1B). A width W2 of the silencer wall 114 can be less than the length L1.

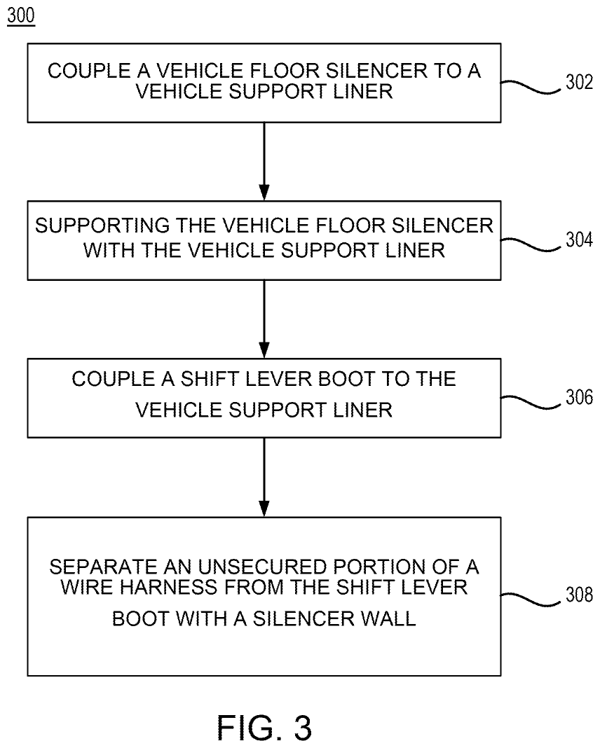

With reference to FIG. 3, a flowchart illustrating a method 300. In various embodiments, the method 300 is a method for preventing an unsecured portion of a vehicle's wire harness from interfering with the vehicle's shift lever boot. For ease of description, the method 300 is described below with reference to FIG. 1A and FIG. 1B. The method 300 of the present disclosure, however, is not limited to use of the exemplary floor silencer system 100 of FIG. 1A and FIG. 1B.

In step 302, the method 300 includes coupling the vehicle floor silencer 110 to the vehicle support liner 130.

In step 304, the method 300 includes supporting the vehicle floor silencer 110 with the vehicle support liner 130. For example, the vehicle floor silencer 110 may rest against the vehicle support liner 130.

In step 306, the method 300 includes coupling the shift lever boot 140 to the vehicle support liner 130 such that the shift lever boot 140 extends at least partially into the opening 150 disposed in the vehicle floor silencer 110. The shift lever boot 140 can be coupled to the support liner 130 with one or more fasteners (e.g., bolts, screws, clips, etc.) and/or an adhesive.

In step 308, the method 300 includes separating an unsecured portion 122 of the wire harness 120 from the shift lever boot 140 with the silencer wall 114 extending from the floor 112 of the vehicle floor silencer 110. The method 300 can further include disposing the silencer wall 114 between the unsecured portion 122 of the wire harness 120 and the shift lever boot 140.

Where used throughout the specification and the claims, “at least one of A or B” includes “A” only, “B” only, or “A and B.” Exemplary embodiments of the apparatuses, the systems, and the methods described herein have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments (e.g., including a singular element where multiple elements are described and/or multiple elements where a singular element is described, etc.) that reasonably fall within the scope of the advancement to the art hereby contributed, and that that scope shall not be restricted, except in light of the appended claims and their equivalents.

What is claimed is:

1. A vehicle floor silencer comprising:
a floor including a sheet of insulating material configured to be mounted to, and conform to, a vehicle support liner; and
a silencer wall protruding from the floor and at least partially defining an opening through the floor so as to accommodate a shift lever boot.

2. The vehicle floor silencer of claim 1, wherein the floor and the silencer wall are formed as a monolithic part.

3. The vehicle floor silencer of claim 2, wherein the silencer wall comprises a rectangular geometry.

4. The vehicle floor silencer of claim 3, wherein a height of the silencer wall is between 4 and 20 times a thickness of the floor.

5. The vehicle floor silencer of claim 2, wherein the silencer wall comprises a first side surface extending from the floor to a top surface of the silencer wall, wherein the first side surface is located opposite the silencer wall from the opening, and the first side surface is oriented at an obtuse angled with respect to the floor.

6. The vehicle floor silencer of claim 1, wherein the floor silencer comprises a synthetic fiber/urethane mixture.

7. The vehicle floor silencer of claim 1, wherein the silencer wall is configured to separate a wire harness from the opening.

8. The vehicle floor silencer of claim 7, wherein the silencer wall at least partially defines a path for the wire harness.

9. A floor silencer system for a vehicle, the floor silencer system comprising:
a support liner;
a floor silencer comprising a floor at least partially covering the support liner and a silencer wall protruding from the floor, the floor extends along and conforms to the support liner and the silencer wall is disposed at an opening in the floor silencer;
a shift lever boot extending at least partially into the opening; and
a wire harness extending across the floor silencer and separated from the shift lever boot by the silencer wall.

10. The floor silencer system of claim 9, wherein an unsecured portion of the wire harness extends across the floor silencer.

11. The floor silencer system of claim 9, wherein the support liner extends from the floor silencer at least partially into the opening.

12. The floor silencer system of claim 11, wherein the shift lever boot extends from the support liner.

13. The floor silencer system of claim 9, wherein the floor and the silencer wall are formed as a monolithic part.

14. The floor silencer system of claim 9, wherein a height of the silencer wall is between one and six times an outer diameter of the wire harness.

15. The floor silencer system of claim 9, wherein a height of the silencer wall is between four and twenty times a thickness of the floor.

16. The floor silencer system of claim 9, wherein the silencer wall comprises a first side surface extending from the floor to a top surface of the silencer wall, the first side surface is located opposite the silencer wall from the opening.

17. The floor silencer system of claim 16, wherein the silencer wall comprises a second side surface extending from the floor to the top surface of the silencer wall, the second side surface is located opposite the silencer wall from the first side surface and the second side surface leans toward the opening.

18. A method comprising:
coupling a vehicle floor silencer to a vehicle support liner;
supporting the vehicle floor silencer with the vehicle support liner;
coupling a shift lever boot to the vehicle support liner such that the shift lever boot extends at least partially into an opening disposed in the vehicle floor silencer; and
separating an unsecured portion of a wire harness from the shift lever boot with a silencer wall protruding from a floor of the vehicle floor silencer.

19. The method of claim 18, further comprising disposing the silencer wall between the unsecured portion of the wire harness and the shift lever boot.

20. The method of claim 19, wherein the floor and the silencer wall are formed as a monolithic part and the silencer wall at least partially defines the opening.
